(19) United States
(12) Patent Application Publication
(10) Pub. No.: US 2012/0257539 A1
(43) Pub. Date: Oct. 11, 2012

(54) METHOD FOR MAC ADDRESSES WITHDRAWAL IN TELECOMMUNICATION NETWORKS

(76) Inventors: Alexander KUGEL, High Wycombe (GB); Igor Shifrin, Petach-Tikva (IL)

(21) Appl. No.: 13/432,452

(22) Filed: Mar. 28, 2012

(30) Foreign Application Priority Data
Apr. 7, 2011 (IL) 212191

(51) Int. Cl. H04L 12/28

(52) U.S. Cl. 370/254

(57) ABSTRACT

A rationalized MAC withdrawal method for a multi-domain communication network, where at least one access node interconnects a remote node with two or more access networks. The method allows flushing, both in the access nodes and in the remote node, only MAC addresses being related to a specific access networks where a topological change has taken place, without affecting other access networks connected to the same access node.

### CROSS-REFERENCE TO RELATED APPLICATIONS

This application claims priority of Israel Patent Application No. IL-212191, filed Apr. 7, 2011, the disclosure of which is incorporated by reference herein in its entirety.

### FIELD OF THE INVENTION

The present invention relates to a technology of relearning MAC (Media Access Control) addresses in modern communication networks, more specifically to a rationalized MAC withdrawal technique in Ethernet networks, Carrier Ethernet networks, and especially in MPLS (Multi-Protocol Label Switching) networks.

### BACKGROUND OF THE INVENTION

Relearning MAC addresses is a well-known procedure in modern communication networks, and usually it takes place when the network topology changes. In such situations, data packets which earlier arrived to some switch/nodes from one source (having MAC address 1) via a specific port of the switch, suddenly start arriving via another port not yet known/familiar to that switch. To relearn the MAC address 1 in association with the new port, the previously learned information (about association of the MAC address 1 with the previous specific port) should be deleted, in other words “flushed” from that specific port (i.e., from the forwarding database (FDB) of the node with respect to that specific port). The flush operation actually means a) deleting the previous information about the MAC address 1 at that port, b) flooding packets addressed to the MAC address 1 of interest via all ports of the switch; c) upon receiving a first response packet from the source having MAC address 1, registering this MAC address 1 in association with the new port via which that response packet has arrived at the switch.

In case of a failure/configuration change either in a node A having MAC address 1 (MAC 1), or in a network section associated with and reachable through that node A (e.g., for a specific service/traffic flow), another node B (e.g., a Core node) not belonging to the mentioned network section but being in communication with the discussed node A, should erase (flush) all MAC addresses of A and the associated network section from its (node's B) FDB.

It is usually initiated by sending a specific message “about changes” to the node B from node A. The the message may list ports to be “flushed”. Alternatively, (if not listed) node B flushes (deletes) MAC address of node A which means any network section reachable through node A becomes “unfamiliar” to node B.

However, the mentioned network section used by the specific traffic flow and appended to a port of node A is usually not the only network section/traffic flow served by node A. Other physical ports, or even other logical ports of node A may serve other traffic flows/network sections and they all will be “flushed’ (will become unknown) together with flushing the node's A MAC from FDB of node B. It will then cause unjustified flooding in the whole network. The slow flush procedure leads to losses of traffic immediately after the flushing and, consequently, causes service disruption.

Simply speaking, there is the following situation. In real networks, not only a single discussed MAC address (e.g., MAC1), but many other MAC addresses can be associated with the port being flushed. Even if MAC 1 moves to another port, other MAC addresses may need to remain registered at the discussed port.

Nowadays, a typical Carrier Ethernet network comprises multi-home regions interconnected by a backbone core network. One of possible implementations of such a network may comprise a number of access networks, so-called Access Rings further aggregated by a Metro/Core MPLS network. The Access Rings may be understood either as physical rings or as logical rings formed in an access network, for example for a specific traffic service.

In the case of any topology change in a specific Access Ring, a Topology Change Notification (TCN) should be delivered to all relevant Core nodes which are part of the services affected by the topology change. A standard mechanism of the approach comprises sending a MAC Withdraw message with a list of MACs (MAC addresses) to be withdrawn (from FDBs of the core nodes). The Core Network Nodes are required to remove all MAC addresses received in the MAC Withdrawal notification.

Such a MAC withdrawal operation is usually based on a so-called Control Path, implemented by software, and requires a relatively long time to be completed. If the message must comprise the full list of affected MAC addresses registered on the affected port, it will not be scalable for large networks. For example, a 10K MACs list just does not fit a regular CCN PDU (Change Configuration Notification Protocol Data Unit). Therefore such a way is slow (may take minutes) and complicated (requires keeping an updated list of MACs in a Central Processing Unit CPU). As a result, a traffic hit may occur during the MAC Withdrawal processing time. An alternative way to withdraw MAC addresses may include sending a “wildcard” MAC withdraw notification which requires removing all MACs registered at the Core Edge (Core node). This usually results in flushing of all MACs, including those received from other access rings/regions at the same Code Node.

The following prior art documents disclose resolving problems of the MAC flush/relearn operations:

CN101330424A discloses a method for handling a service failure of a virtual private network and relates to the technical field of network communications. The method comprises the following steps: a second provider edge device (PE) sends a Flush message to a switch when a failure occurs between a first client edge (CE) device and a second CE device, wherein the second PE device turns into a forwarding state; eliminating a medium access control (MAC) address list of the switch according to the Flush message; eliminating a MAC address list of a third PE device. The invention further discloses a virtual private network (VPN) failure handling system, which comprises the switch, a first PE device, the second PE device and the third PE device. The method solves the problem that a CE dual-homing network switch interface of a virtual private LAN service (VPLS) network cannot update in time, so as to improve the reliability of the VPLS network. The CN101330424A actually describes a standard MAC withdrawal method/message mentioned above in the background description, and does not propose a solution for MPLS networks.

U.S. Pat. No. 6,330,229B describes an approach for management of forwarding databases in the case of link failures on bridges according to the all improved spanning tree, which limits the propagation of notifications of topology change to only those parts of the network which are affected by the link failures, and triggers partial flushing as opposed to complete forwarding database flushing of learned MAC addresses to relearn the sets of addresses associated with ports affected by the change in topology. When a bridge moves its root port to a new port, the bridge can move the addresses learned through the original root port to the new root port without any relearning. The sets of addresses associated with the designated ports on upstream bridges from the old root port, are subject to flushing. Also when the bridge attaches to the new branch, it triggers a message to the root instructing all bridges in the new path to the root to flush addresses learned on their root ports. Actually, the solution is for Provided Bridge (PB) networks, and suggests transferring lists of MACs from one port to another port.

Neither of the published or practically used prior art solutions are known tp propose an effective way of rationalizing the MAC withdrawal procedure, and especially in MPLS networks.

### OBJECT AND SUMMARY OF THE INVENTION

It is an object of the invention to create a modified mechanism for intelligent MAC learning with a rationalized MAC withdrawal (flush) procedure.

Two goals of the rationalized MAC withdrawal in a network are formulated comprising a number of component network domains:
firstly, flushing in an intermediate (access) node only those MAC addresses (MACs) which are related to a specific access network (access Ring, access network domain) where a fault or change took place, without affecting other access networks which may be connected to the same access node.
secondly, also in a remote node (e.g., in a Core Network Element being part of a core network domain) connected to a number of access nodes, flushing only those MACs which are associated with the specific Access Ring/Domain where a Topology Change actually occurred.

The two goals actually form one version/embodiment of the invention: a rationalized MAC withdrawal method in a communication network comprising two or more component network domains with network nodes, wherein an intermediate node interconnects a remote node with two or more said component network domains accommodating MAC addresses (MACs). One aspect of the method allows and comprises:
in the intermediate node, flushing only MACs being related to a specific network domain (connected to said intermediate node), where a fault or change has taken place, without affecting other network domains (e.g., access networks/rings) connected to the same said intermediate node; and
in the remote node connected to said intermediate node, flushing only MACs associated with said specific network domain.

To achieve the goals and to perform the method of rationalized MAC addresses (MACs) withdrawal in the mentioned communication network comprising two or more (component) network domains of network nodes, the following steps preferably be provided:
a) assigning unique IDs to the network domains;
b) sending data frames in the network with indication of ID of a network domain from which the frame originates, to allow learning of MACs at the network nodes in association with the network domains respectively originating said MACs; and
c) sending a notification of topology changes (failure or other) in the network with indication of the ID of the network domain where the topology change occurred, to allow performing, at the network nodes, of withdrawal (flush) only of MAC addresses related to the changed network domain.

A more specified method may explicitly comprise learning MACs at the network nodes in association with the network domains from which said MACs respectively originated, and, in case of a topology change and upon receiving the suitable notification at the network node(s), consequently comprises flushing at the node(s) only MAC addresses related to the changed network domain.

The “remote node” (which is sometimes called a core node in this application) should be understood as a node which is not directly connected (does not belong) to the access ring; the core node and the access rings/domains usually have intermediate (access) nodes there-between.

MACs in the FDB of a network node (and in a specific case, in the remote/Core node) are considered to be associated with a particular access ring/domain if they were received (i.e., learned) from that ring/domain.

It should be noted, however, that the network node which constitutes an intermediate node for one constellation of network domains, may be a core node for another constellation (group) of network domains of one and the same combined network.

The technology is proposed preferably for MPLS networks, though it can be used also in Ethernet networks and in any kind of segmented networks where address learning is used for forwarding data packets/frames, and various control protocols are used to control network topology to eliminate loops. Preferably, the core network is an MPLS network.

The access networks (rings) may be understood either as physical rings such as fiber rings, or as logical rings formed in any access domain (for example in a mesh-like network) for a specific traffic service. Such rings typically utilize redundancy nodes (usually, a dual homing configuration).

The dual homing nodes are usually intended for providing protection to traffic services which are to be passed to a remote/core network (where a destination core node receives the traffic). Usually, the traffic is bidirectional, i.e. the core node may become a source node and send data frames to access networks. The access rings are usually open, i.e. have a physical or a logical gap to prevent forming loops (which is provided either manually or by loop-preventing algorithms such as x-STP, ERP, etc.)

The method allows rationalizing the MAC withdrawal procedure (flushing of MAC addresses) already at the level of component access networks connected to two or more access nodes.

In a communication network comprising at least two access nodes connected to access networks (access Rings), wherein at least one of the access nodes is connected to two access networks, the method of flushing MAC addresses in a specific access node comprises:
assigning said ID, which is a Ring domain ID (RID), to each access network (Ring) and sending RID with every data frame outgoing from a specific access network/ring;
in an access node out of said access nodes, associating the RID received in a data frame, with a specific port of the access node;
associating MAC address of said received data frame with the port of the access node to which the frame arrived, thus learning the MAC address for said port;
in case of a change in topology (failure, protection switching, etc.) of said specific access network/ring, providing a notification about it to the access node, and indicating in the notification the RID the changed access network; and
flushing from the access node only those learned MAC addresses which are associated with the changed specific access network, by flushing only MACs learned for the specific port associated with RID of the specific changed access network.

The notification may be understood, for example, as a MAC withdrawal CCN (configuration change notification) and the notification should contain the ID of the topologically changed domain (e.g., RID—ID of the reconfigured/failed ring). For access/intermediate nodes such a notification already allows rationalizing the flushing procedure, since RID is associated with a specific port, and MACs registered to such a port will be withdrawn. The remote notification may comprise a list of IDs (RIDs) in case topology changes occurred in a number of network domains associated with the specific access node.

In a more advanced version of the method, the network comprises a core node connected to said access nodes; the method also comprises a procedure of rationalized flushing of MACs in the core node, by performing the following operations:
At the core node, associating the MAC of a data frame, arrived to the core node, with a combination of RID provided in the frame and an access node from which the data frame has arrived, (said combination may be called a virtual port);
learning (i.e. registering) MACs in the core node according to virtual ports to which the MACs are associated;
in case of a topology change in an access network/ring, providing a remote notification from an access node to the core node, the remote notification marking RID of the failed access network (actually, the remote notification may comprise a list of RIDs if a number of access networks associated with a specific access node have failed); and
Flushing in the core node only MACs associated with the virtual port(s) which are a combination of the access node from which the notification has been received and the RID of the failed network marked in the remote notification.

The necessary indications (of the intermediate node, of the access ring) can be performed either by using tags (labels) of MPLS packet, or by using various fields of an Ethernet packet. The remote notification is actually a new type of a topology change notification, which has been proposed by the Inventors. It should be mentioned that such a remote notification to a remote/core node did not exist before.

Therefore, in the communication network at least one intermediate/access node interconnects a remote/core node with two or more of component network domains (access networks). The method further comprises sending one of said notifications of topology change from an intermediate node to the core node, and such a specific notification will be a remote notification informing the core node about topology change in a specific network domain associated with said intermediate node.

The following preliminary steps may be performed for the method:
Dividing a given communication network (i.e., the physical topology of the given network) into network domains, there-among for example a so-called core network comprising at least one core node and two or more access rings (which will intermittently be called rings/domains/networks in this description) connected to the core network by a group of access/intermediate nodes (As noted above, the access ring may be not only a physical ring but also be just a logical ring and/or a service ring); and
Assigning a unique network domain ID to each network domain, in particular—to each access network; and still further—at any node being intermediate/access node for network domains/rings connected to it, assigning the network domain IDs to ports of the access node connected to respective access networks).

According to another aspect of the invention, the proposed method may be considered as an independent technique for rationalizing MAC withdrawal at a core node. At least at a core node (but preferably, at any node of the network since it may be a core node to other network nodes), the method suggests:
learning MAC addresses while receiving a data frame/packet, by registering MACs in FDB of the core node according to a combination comprising the following indications (the combination may be called a virtual interface):
   an indication of an intermediate node of the mentioned group (such as an access node), from which the data frame has arrived to the core node, and
   an indication of ID of the network domain/ring from which the data frame previously arrived to the intermediate node;
in case of any topology change (fault, etc.) in a specific network domain/access network, notifying the core node by an intermediate/access node from the group associated with the “changed” network domain about changes of topology of that specific network domain; and
performing withdrawal of those MAC addresses registered in FDB of the core node, which are associated with the network domain affected by the topology change. It should be noted that MAC addresses learned at the core node may be associated with different access nodes, but still with the same “changed” access network. This means that various virtual ports will not be affected, but only those which comprise RID of the “changed” domain).

According to another aspect of the invention there is also proposed a network dividable into a number of network domains comprising a core network and two or more access networks with a group of intermediate (access) network nodes being interconnected with a core node located in the core network, the network being adapted to implement the above-described optimized method of flushing MAC addresses.

There is also proposed a software product comprising computer implementable instructions and/or data for carrying out the method as described above, the software product being stored on an appropriate non-transitory computer readable storage medium so that the software is capable of enabling operations of said method when used in a computer system.

The computer system may be understood as a distributed system comprising control& processing units (CPUs) of the intermediate nodes and the core node. The computer system may be a node's control block CPU, such as in the form of a network element management system EMS, or the network management system NMS, or a combination thereof.

It should be reminded, however, that a network node being an intermediate node for one constellation of network domains, may be a core node for another constellation (group) of network domains. Therefore, the software product may be accommodated in its complete version in one node, and may be distributed between different nodes as well.

The invention will be further described and illustrated in detail as the description proceeds.

### BRIEF DESCRIPTION OF THE DRAWINGS AND PREFERRED EMBODIMENTS

The invention will be further described and illustrated with the aid of the following non-limiting drawings in which:

FIG. 1A (prior art) is a schematic block diagram that schematically illustrates a first aspect of typical communication network which suffers from the problem of a complex MAC withdrawal procedure, first step.

FIG. 1B (prior art) is a schematic block diagram that schematically illustrates a next step of the complex MAC withdrawal procedure in the network shown in FIG. 1A.

FIG. 2A is a schematic block diagram that is a schematic illustration of an exemplary network where the proposed method may be implemented.

FIG. 2B is a schematic table of an illustration of a VC-label of a regular MPLS data frame, comprising indication of ID of a network domain.

FIG. 3A is a schematic table illustrating how so-called “virtual ports” may be presented (and registered) at a core node, to simplify the MAC withdrawal operation.

FIG. 3B is a schematic table that schematically illustrates how various MAC addresses can be learnt at a core node.

FIG. 4 is a schematic table that illustrates how the forwarding operation can be organized in a core node.

FIG. 5 is a schematic table that schematically shows an example of a modified notification (CCN) which may be sent from an access node to a core node.

### DETAILED DESCRIPTION OF PREFERRED EMBODIMENTS

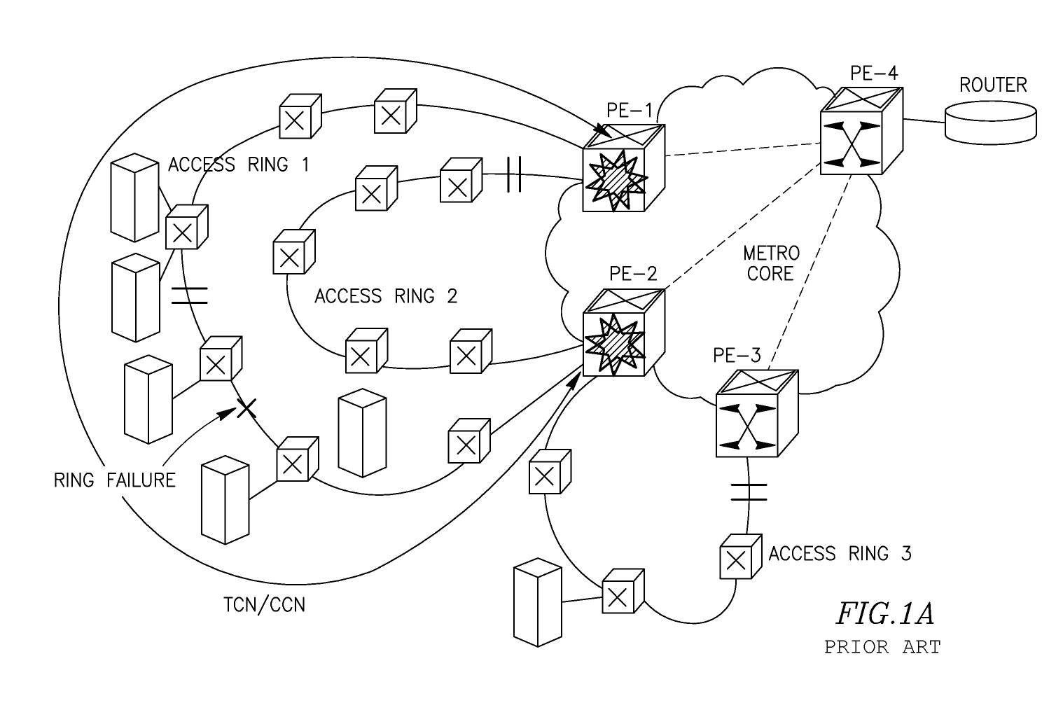

FIG. 1A (prior art) shows a typical though exemplary topology of a combined network comprising a number of access network domains (rings)—Access Ring 1 (R1), Access Ring 2 (R2), Access Ring 3 (R3) connected to three access (intermediate) nodes PE-1, PE-2 and PE-3. The access nodes connect the access networks and a Metro core network comprising a core node PE-4 which is a destination node for traffic being held between access networks and the node PE-4.

The problem known in the prior art is as follows. In case of failure in one of the access rings (e.g. Ring 1, see a cut shown by a “cross” which will cause protection switching in the Ring 1), a topology change notification will be sent to PE-1 and PE-2 (shown by circular arrows), and both PE-1 and PE-2 will flush MACs per bridge/node (see symbolic explosions on the nodes PE-1, PE-2), i.e. for all MACs registered in these nodes. Traffic on the access network/rings R2 and R3 will also be affected since MAC addresses of R2, R3 learned in the PE-1, PE-2 will be withdrawn due to the flush of R1, R2.

FIG. 1B (prior art) shows that when a communication service established between access nodes and a core node PE-4, in case of a failure (see FIG. 1A) a configuration change notification (CCN) will be sent from nodes PE-1, PE-2 (see solid arrows) to node PE-4. As a result, node PE-4 will flush all MAC addresses registered in its Forwarding Data Base (FDB). Traffic of Rings R2 and R3 will be affected and the process of flooding and relearning will overload the network (from the point of bandwidth, resources and time). After the learning process affected by BSC (Broadcast Storm Control policing—method to control flooding in the network) which takes time, the traffic will be fully restored.

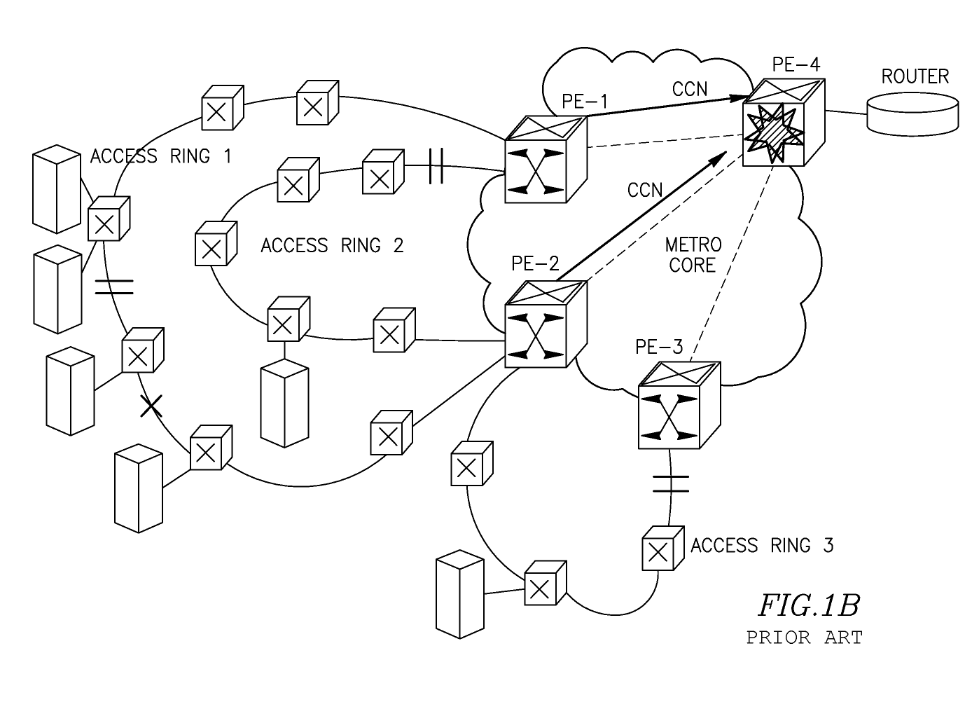

FIG. 2A schematically shows the network of FIGS. 1A, 1B where the proposed method will be implemented if the following steps described herein are performed: Firstly, IDs should be assigned to network domains (at least to the access rings R1, R2, R3)—the IDs are respectively marked as RID1, RID2, RID3 . . . Further, on access to nodes PE-1, PE-2, PE-3, Ring IDs should be assigned to ports of each specific access nodes connected to each specific ring. For Example, 16 ports may be assigned to 8 rings (since each ring requires 2 ports at the access nodes).

The network nodes should be adapted to produce modified CCNs in case of a fault, carrying indication of the relevant RID where the fault occurred.

CCN* is a CCN concerning a fault in access ring R1.

CCN** are CCNs sent from PE-1 and PE-2 to a remote (core) node PE4, carrying indication of the fault in access ring R1 by including it in a list of failed access rings.

As a result:

P1 and P2 will flush MAC addresses in response to the CCN*, but traffic from Rings 2 and 3 should be unaffected by PE-1 and PE-2 flushes. It can be done if PE-1 and PE-2 flush only MACs on the same ring R1, and that can be implemented by two separate flushes per [VSI (service), port]. The ports to be flushed can be found by Ring ID (RID1), since it is assigned to the relevant ports of PE-1 and PE-2.

VSI is a service. All services from the same port will be flushed together if they are triggered by the same CCN/alarm. In the general case they are flushed separately. A number of services (rings) may pass via one port, and each service ring, if necessary, will be “flushed” separately.

Further, according to the CCN**, PE-4 should flash only MACs previously learned as originating from Ring-1. To do that:
PE-4 should be able to learn MACs with remote Ring IDs
the customized MAC withdraw messages (CCN**) should be sent from PE-1 and PE-2 with Ring ID (Ring-1 in our case, as a problematic ring)
PE-4 should be able to flush only MACs received from PE-1 and PE-2, and located on Ring-1.

To propagate information about access rings in the network, the Inventors propose that data frames in the network (at least the data frames outgoing from access nodes to a core node) carry indication of the access ring from which a specific frame originates.

FIG. 2B schematically illustrates the above suggestion, according to which, for example, PE-1 and PE-2 will attach Ring ID to every MPLS data frame forwarded to PE-4.

The ring ID can be transferred in a number of ways:
by modifying a VC-label scheme, where only 17 of 32 bits are strictly busy with standardized information. So, for example, a ring ID may be coded by using bits 17-19 of the VC-label;
by using Pseudo Wire EXP bits; but they are not used in some applications.
   By adding a proprietary (nonstandard) message with a specific ring ID after the control word.

There is special field which may be added in a proprietary implementation—a new field well known in the proprietary frame layout—for example, it is the 1^{st} byte immediately after the MPLS stack.

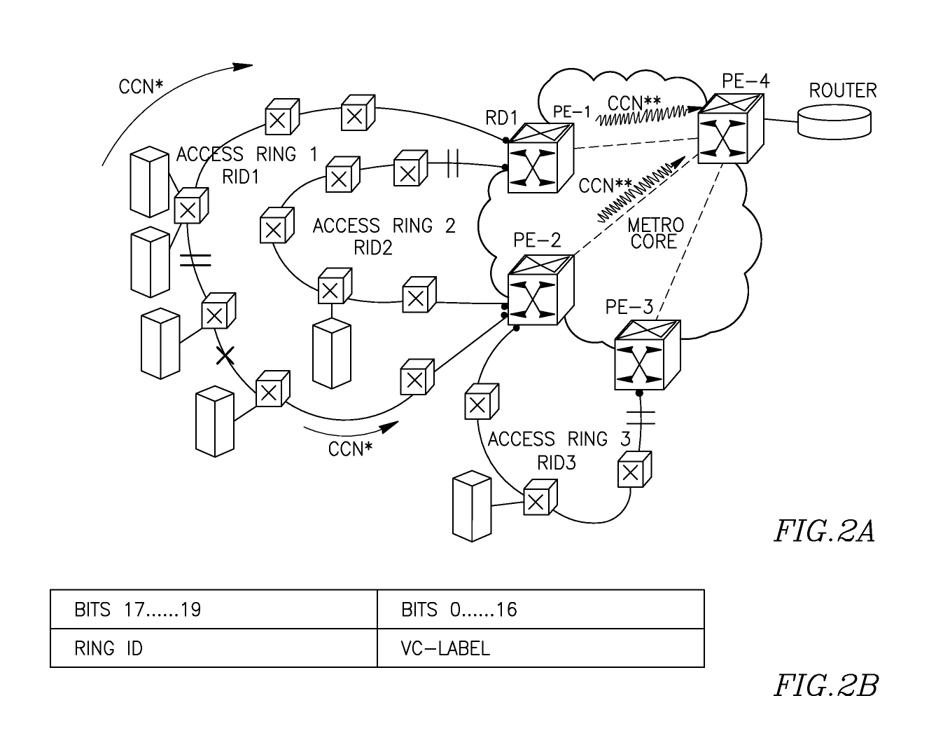

FIGS. 3A and 3B present tables which help to understand the process of learning MACs at the core node PE-4.

Learning of MAC addresses at the core node may be performed in a number of sub-steps:

The first sub-step requires providing the core node with the ring/network domain ID of a packet (see FIG. 2A and the related description);

The next sub-step of learning MAC addresses by the core node requires “extracting” the ring IDs from the received packets arrived from one or another intermediate nodes, and building a table of virtual ports (an example is in FIG. 3a). The table can be built by mapping (assigning) the received “combination” of the intermediate node and the ring IDs to a specific so-called Virtual port. In such a manner, there are organized a number of known combinations of the intermediate nodes and the ring IDs=a number of known Virtual ports. The table similar to that shown in FIG. 3A can be arranged in the FDB of the core node. Then, a further step will be the very step of learning MACs at a core node.

FIG. 3B. Each specific MAC address, appearing in a data frame arriving to the core node within a specific traffic service (say, a VPN service having its ID), will be registered in FDB according to the Virtual port to which the MAC seems to belong according to the information in the packet and the data already stored (FIG. 3a) in the core node. This can be done by building another table in the FDB of the core node—see FIG. 3B, which is a table of MACs.

Remote (core) nodes in other remote Domains/Regions perform learning of MAC addresses according to a virtual interface, where each virtual interface is a combination of the access PE and the Network ID of the Region originating the received MAC.

According to FIG. 2A, together with FIGS. 3A and 3B, PE-4 learns MACs coming from PE-1 per following virtual interfaces: {PE-1, Access-ring-1} and {PE-1, Access-ring-2}

PE-4 learns MACs coming from PE-2 per following virtual interfaces: {PE-2, Access-ring-1}, {PE-2, Access-ring-2} and {PE-2, Access-ring-3}.

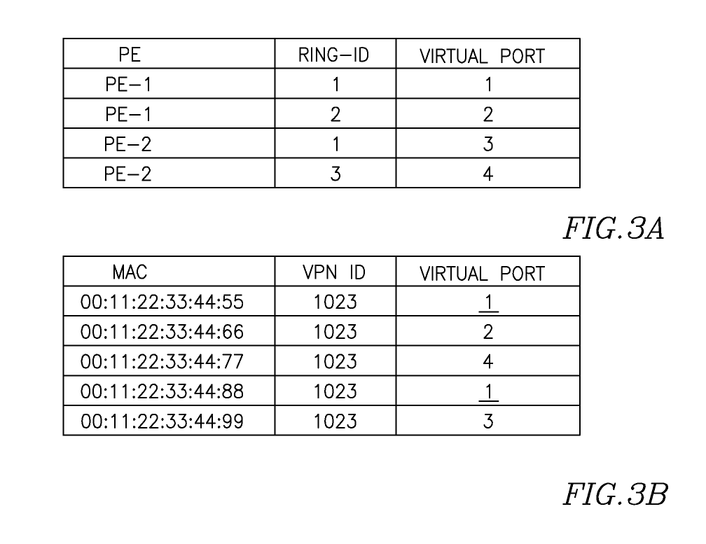

FIG. 4 illustrates how the core node forwards information to known MAC addresses. The learned information about MAC addresses is regularly used by the core node and is used when forwarding packets from the core node:
When forwarding known MAC addresses (MACs), they are forwarded to specific virtual ports in the specific intermediate nodes (PEs), so these packets will arrive via correct ports in the intermediate nodes to the correct access network domains (FIG. 4).
when flooding data (i.e., when MACs are unknown to the FDB), the core node will flood the packets to all intermediate nodes, not to virtual ports thereof—and thus such packets will arrive to all addresses in the network.

As mentioned in the Summary of the invention, responsible access nodes notify remote peers (such as PE-4) on a topology change in the relevant domain. For example, PE-1 and PE-2 will notify the PE-4 about the topology change in the Access Ring-1.

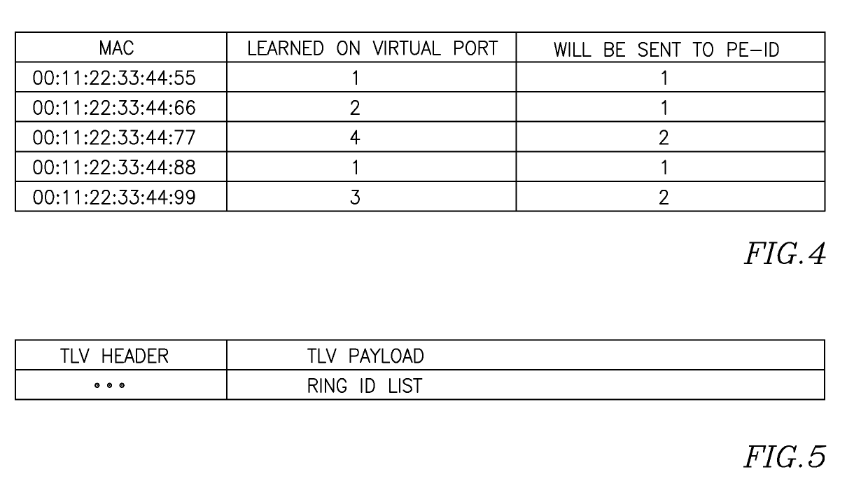

FIG. 5 shows an example of a modified CCN for notifying a core node about such a change or failure (so-called remote notification).

The step of notifying the core node about failures/changes in a specific access network (ring) may comprise the following possible sub-steps:
Intermediate nodes send a customized Change Notification (CCN) to the core node with a new TLV portion containing a list of changed access domains/rings. The list may comprise one or more ring IDs, for example PE1 sends “Ring ID 1” (FIG. 5).
In response, Remote PE-4 will perform withdrawal of all MACs registered on the affected virtual interfaces. I.e. PE-4 will perform MAC flushing of all MACs registered on interfaces {PE-1, Access-ring-1} and {PE-2, Access-ring-1}.

The step of MAC withdrawal (flushing) which does not affect non-changed network domains may comprise the following sub-steps performed at the core node (such as PE4):
receiving a CCN (e.g., as in FIG. 5), determining a changed ring ID indicated in the CCN, and according to that ring ID and the PE who sent the message—finding the relevant virtual (according to FIG. 3A, for Ring-ID 1 and the node PE-1, the virtual port is 1);
flushing all MACs registered to this virtual port, per service (say, VSI). For example, flushing i.e. deleting all MACs registered to the Virtual port 1 (FIG. 3B, virtual port 1 is underlined).

Since, most probably, PE-2 also sends CCN indicating “Ring-ID 1”, MACs registered to Virtual port 3 will also be flushed in PE-4. As a result, the core node flushes only MACs known to the core node from the changed Ring having ID 1, while MACs in other network domains (rings) are not affected.

Flushing MACs per virtual interface can be further rationalized and shortened if the process is performed according to the Applicant's earlier and yet non-published patent application IL 205725 which is incorporated herein by reference.

The invention has been described with reference to the included examples and drawings, but may be implemented in a number of additional versions and embodiments which should be considered part of the invention whenever covered by the claims which follow.

1. A MAC withdrawal method in a communication network comprising two or more network domains with network nodes and MAC addresses (MACs), communication between the network nodes being performed by data frames; the method comprising:
a) assigning unique IDs to the network domains;
b) providing each data frame with indication of ID of a network domain from which the frame originates;
c) learning of MACs at the network nodes in association with their respective network domains;
d) in case of a topology change in said communication network, sending a notification of a topology change with indication of ID of a specific network domain where said change occurred; and
e) at the network nodes, performing MAC withdrawal only of those MACs related to the specific network domain where said topology change occurred.

2. The MAC withdrawal method according to claim 1, wherein, among said network nodes, an intermediate node interconnects a remote node with two or more said component network domains; whereby there is flushing, both in said intermediate node and in said remote node, only of MACs being related to said specific network domain where a topology change has taken place.

3. The method according to claim 1, wherein the component network domains are access networks comprising two or more said network nodes being access nodes, and wherein at least one of the access nodes is connected to two said access networks, the method comprises:
assigning said ID being a Ring domain ID (RID) to each of the access networks and sending RID with every data frame outgoing from a specific access network; in an access node selected out of said access nodes, associating the RID received in a data frame, with a specific port of the access node;
associating MAC address of said received data frame with the port of the access node to which the frame arrived, thus learning the MAC address for said port;
in case of a change in topology of said specific access network, providing a notification about it to the access node, and indicating in the notification the RID of the specific access network; and
flushing from the access node only those learned MAC addresses which are associated with the specific access network, by flushing only MACs learned for the specific port associated with RID of the specific access network.

4. The method according to claim 1, wherein the notification of topology change is a MAC withdrawal configuration change notification (CCN) containing ID of at least one topologically changed network domain.

5. The method according to claim 2, wherein the remote node is a core node connected to said intermediate nodes being access nodes; the method comprises a procedure of rationalized MAC withdrawal in the core node, by performing the following operations:
at the core node, associating MAC of a data frame, arrived to the core node, with a virtual port being a combination of RID provided in the frame and an access node from which the data frame has arrived;
learning MACs in the core node according to virtual ports to which the MACs are associated;
in case of a topology change in one of the network domains associated with a specific access node, providing a remote notification from the specific access node to the core node, the remote notification marking RID of the changed network domain; and
flushing in the core node only MACs associated with one or more virtual ports being a combination of the access node from which the notification has been received and the RID of the network domain marked in the remote notification.

6. The method according to claim 1, comprising the following preliminary steps:
dividing a given communication network into the component network domains, there-among a core network comprising at least one core node and two or more access networks connected to the core network by a group of access nodes; and
assigning a unique network domain ID to each access network, at any node being an access node for access networks connected to it, assigning the access networks' IDs to ports of the access node connected to respective access networks.

7. A method of MAC withdrawal in a communication network divided into component network domains comprising a core network having at least one core node and two or more access networks having respective access nodes; the network domains communicating by data frames, the method comprises:
learning MAC addresses (MACs) while receiving a data frame by registering MACs in a forwarding database (FDB) of the core node according to a virtual interface being a combination comprising:
an indication of the access node, from which the data frame has arrived to the core node, and
an indication of ID of the access network from which the data frame previously arrived to the access node;
in case of a topology change in a specific access network, notifying the core node about it by the access node associated with the specific access network;
performing withdrawal only of such MACs registered in FDB of the core node, which are associated with ID of the access network affected by the topology change.

8. The method according to claim 1, wherein, among said network nodes, at least one intermediate node interconnects a remote node with two or more said component network domains;
the method further comprises sending the notification of a topology change from an intermediate node to the core node, wherein said notification being a remote notification informing the core node about the topology change in a specific network domain associated with said intermediate node.

9. A network divided into a number of network domains comprising a core network and two or more access networks with a group of access nodes being interconnected with a core node located in the core network, the network being adapted to implement the method according to claim 1.

10. A software product comprising computer implementable instructions and/or data for carrying out the method according to claim 1, the software product being stored on an appropriate non-transitory computer readable storage medium so that the software is capable of enabling operations of said method when used in a computer system.
